(19) United States
(12) Patent Application Publication
(10) Pub. No.: US 2008/0035440 A1
(43) Pub. Date: Feb. 14, 2008

(54) Braking Device

(76) Inventor: Heinz Hoeller, Crailsheim (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/662,216

(22) PCT Filed: Aug. 3, 2005
(86) PCT No.: PCT/EP05/08390

§ 371 Date: Sep. 7, 2007

(30) Foreign Application Priority Data
Sep. 8, 2004 (DE) 10 2004 043 304.6

(51) Int. Cl. F16D 57/02; B60L 7/28

(52) U.S. Cl. 188/296; 188/161

(57) ABSTRACT

The invention relates to a braking device having a rotor and a stator; the rotor and the stator are arranged relative to each other in such a way and a working medium can be supplied or engaged in such a way that, during braking operation when working medium is supplied or engaged, braking torque is transmitted from the rotor to the stator. The braking device of the invention is characterized by the following features: a fan wheel is provided, which, by means of activation and deactivation of a coupling, can be switched into and out of a driven connection with the rotor; the fan wheel is designed and positioned in such a way that, in switched driven connection with the rotor, a flow of cool air is supplied to the braking device; the coupling is arranged and subjected to the working medium in such a way that supplying or engaging and carrying away or disengaging the working medium automatically activates and deactivates the coupling.

The invention relates to a braking device, particularly for use in relatively small vehicles, such as trailers or small trucks or rail vehicles.

Nowadays, it is common to brake trucks or rail vehicles on, for example, inclines with wear-free sustained-action brakes in order to relieve the service brakes that are always provided in addition. Employed for this are, in particular, electrodynamic retarders, also referred to as eddy current brakes, or hydrodynamic retarders. Both of these wear-free sustained-action brakes use a working medium by means of which braking torque or simply torque is transmitted from a rotor, driven by the drive train to be braked, to a stator. In the case of eddy current brakes, the electric current that is used to create the electromagnetic field between the rotor and the stator may be designated as the working medium; in the case of the hydrodynamic retarder, the working medium is a fluid—for example, a hydraulic oil or else water—that creates a circuit flow in a toroidal working chamber, formed by the rotor and the stator, for transmitting braking torque.

As a rule, such sustained-action brakes are cooled by an external oil or water cooling circuit in order to carry away the heat produced during the braking operation. Arranged in the cooling circuit is an appropriate heat exchanger in order to draw off heat that is absorbed by the cooling medium in the region of the retarder to the surroundings or to another cooling circuit. In the case of the hydrodynamic retarder, the latter may also be integrated into the vehicle cooling circuit when the cooling medium of the vehicle cooling circuit is, at the same time, the working medium of the retarder (in the case of so-called water retarders). However, when such a wear-free sustained-action brake is to be employed in a comparatively small vehicle—for example, in a small truck or a trailer, no suitable cooling circuit is available, as a rule, in order to cool the sustained-action brakes during the braking operation. The separate provision of a suitable cooling circuit is associated with such high costs and design difficulties that, in such small vehicles, the use of sustained-action brakes has been dispensed with up to now.

Reference is made to the following documents in regard to the published prior art:
GB 1,211,629 A
U.S. Pat. No. 5,819,697 A
U.S. Pat. No. 3,958,671 A
EP 0531,721 A

The invention is based on the problem of creating a braking device that is compact in construction and that does not need any external cooling circuit.

The problem of the invention is solved by a braking device having the features of claim 1. The dependent claims describe especially advantageous further developments of the invention, particularly, in one case, the configuration of the braking device as an eddy current brake and, in the other case, the configuration of the braking device as a hydrodynamic retarder.

Provided in accordance with the braking device of the invention is a fan wheel that is switched on during braking operation in order to cool the braking device by means of a flow of cool air. The fan wheel can be provided, for example, with ribs or blades on its surface, which, through the rotation of the fan wheel, blow cool air in the direction of the braking device, that is, in the direction of the rotor and the stator. The cool air can be guided over an outer-lying and/or an inner-lying surface of the braking device in order to absorb by means of convection the heat that is produced in the braking device.

Provided in order to engage the fan wheel when transitioning from non-braking operation to braking operation and to disengage it when going from braking operation to non-braking operation is a coupling, which is automatically activated and deactivated. In the sense of the invention, activated is understood to mean that the coupling connects the fan wheel to the rotor in a driven connection; deactivated is understood to mean that the connection is again disengaged, so that the fan wheel is not driven any longer, transitions into idle spinning operation, and finally comes to a standstill.

The activation and deactivation of the coupling occurs automatically and, namely, in particular, directly through supplying or engaging or else carrying away or disengaging the working medium. In the case of an eddy current brake, formed in accordance with the invention, the coupling can be activated, for example, by delivering electric current through the braking device in order to produce the corresponding magnetic field for braking, this current being used simultaneously for activating the coupling. For example, the coupling can be actuated electromagnetically, particularly in the form of a movable piston that produces a frictional connection or a mechanical lockup between the rotor and the fan wheel by being moved by means of a magnetic force that is produced along with the activation of the braking current.

In the case of the configuration of the braking device of the invention as a hydrodynamic retarder, pressure is advantageously precisely applied to the coupling by way of the working medium—for example, oil or water—at the very time when the working chamber of the retarder is filled so as to build up the circuit flow required for the braking. For example, the working medium on which pressure is applied can be withdrawn from the working chamber via a pressure line, which is connected to the working chamber in the region of the outer circumference, and carried to one side of a movable piston, so that the pressure of the working medium displaces the piston. The displacement of the piston can, similarly to the case of the eddy current brake described, create a frictional connection or a mechanical lockup between the rotor and the fan wheel in order to achieve the driven connection of the invention between the rotor and the fan wheel during braking operation.

The piston, which forms, in particular, at least one part of the coupling, for example, can take the form of an annular piston, the central axis of which coincides with the axis of rotation of the rotor and which can be displaced in the axial direction, that is, in the direction of the axis of rotation of the rotor so as to produce the mechanical coupling engagement between the fan wheel and the rotor. Coupling engagement is understood here to mean any mechanical couplings, particularly friction couplings, claw couplings, multidisc couplings, couplings via bolt engagement, or centrifugal couplings.

An embodiment example of a braking device of the invention, which is designed as a hydrodynamic coupling and having an especially compact construction, will be described in greater detail below on the basis of the figures.

Shown are:

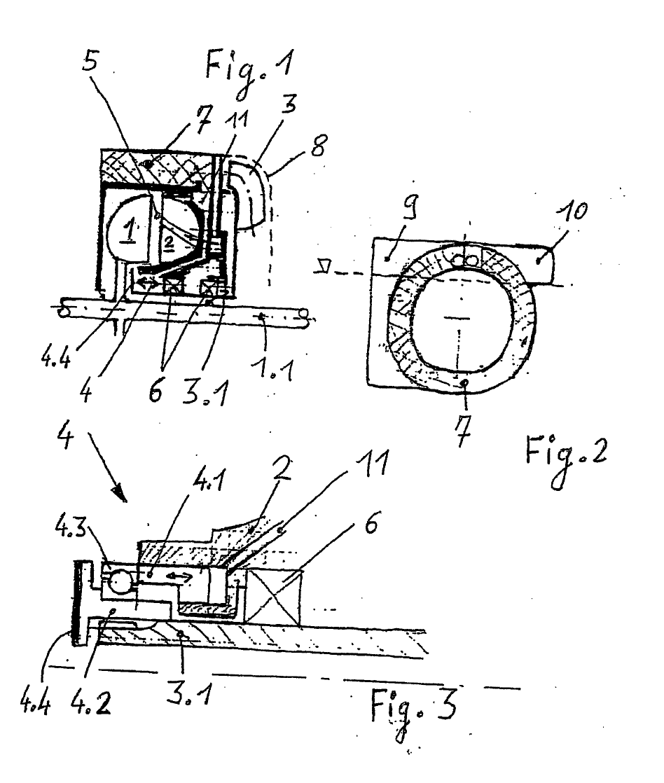

FIG. 1 an axial section through a braking device designed in accordance with the invention;

FIG. 2 a schematic front-end view of the braking device of FIG. 1;

FIG. 3 an enlarged depiction of the radially inner region of the braking device of FIG. 1, which shows, in particular, the coupling.

Evident in FIG. 1 is the rotor 1 of the hydrodynamic retarder, which has a rotor shaft 1.1, by means of which it is arranged so as to be able to rotate. The blade wheel of the rotor 1 forms, together with the blade wheel of the stator 2, which surrounds the rotor 1, a toroidal working chamber 5, in which a annular flow of working medium is created during braking operation. This construction is generally known for retarders by the person skilled in the art, so that it needs no further explanation.

However, deviating from the prior art, the retarder in accordance with FIG. 1 has an annular heat exchanger 7, which is arranged along the outer circumference of, that is, radially outside, the working chamber 5. The working medium is guided out of the working chamber 5 into this annular heat exchanger 5*, cooled there, and conveyed back into the working chamber 5. The annular heat exchanger 5* is accordingly loaded on its inner side, that is, on its heat-absorbing side, with working medium as heat-transfer medium.

In order to carry off the heat from the working medium in the annular heat exchanger to the surroundings, cool air flows over the annular heat exchanger 7 on its heat-emitting side. Here, the necessary flow of cool air is produced by the fan wheel 3, which is arranged on the front side of the retarder and is protected against access from the outside by means of a safety grid 8. The fan wheel 3 bears, for example, ribs or, as depicted, blades, which produce a radial-axial flow of air. The rotation of the fan wheel 3 causes the air that is “scooped up” by the blades to accelerate radially outward and to be subsequently diverted axially so that it flows directly against and/or along the annular heat exchanger 7.

The fan wheel 3 is borne on a fan shaft 3.1 and, in particular, is constructed integrally with the latter. Here, the fan shaft 3.1, as can be seen particularly in FIGS. 1 and 3, is mounted in the stator 2 by means of the bearing 6 so as to be able to rotate. The fan shaft 3.1 is constructed as a hollow shaft that surrounds the rotor shaft 1.1. The rotor shaft 1.1 can be mounted, for example, outside stator 2 or else on stator 2 or inside stator 2 (not depicted).

As depicted schematically in FIG. 2, the hydrodynamic retarder has a conventional actuation via the oil reservoir; see the reference number 9. By means of compressed air from the vehicle compressed air system, air pressure is applied to the oil (or the water) of the retarder, which represents the working medium, in order to transport this working medium into the working chamber. The air that is present during non-braking operation in the working chamber of the retarder, which is then drained or partially drained, is carried off via an exhaust-air system 10 so that the working chamber can be appropriately filled with working medium when switching occurs from non-braking operation to braking operation.

Obviously, it is also possible to switch on the retarder in other ways than with compressed air, which, in particular, is controlled via an electrically switched proportional control valve. For example, an oil piston driven by an electric motor may be used in order to introduce the oil (or the water) into the working chamber of the retarder at the beginning of the braking operation.

Evident in FIG. 3 is, in particular, the coupling 4 of the retarder of the invention, which serves to bring the fan wheel 3 into a driven connection with the rotor 1 on transitioning from non-braking operation to braking operation, so that the fan wheel 3, which is at a standstill during non-braking operation, is caused to rotate so as to produce the desired flow of cool air. The coupling 4 comprises an annular piston 4.1, which is L-shaped in cross section, as can be seen in FIG. 3, and, namely, has the shape of an L lying on its side, so that the short arm of the L is directed downward. The piston 4.1 is pressure-loaded on its first axial front end—on its right front end in FIG. 3—with working medium, which is supplied through the channel 11. The channel 11 is constructed in the stator 2 and opens into a region of the stator 2 that surrounds the annular piston 4.1 in a sliding connection, this region being designed in such a way that the piston 4.1 can be displaced axially inside stator 2 and, at the same time, is borne by stator 2, in particular, exclusively by stator 2. On its opposite-lying end, that is, on its inlet end, the channel 11 can open, for example, into the region of the radially outer circumference of the working chamber 5, as is depicted in FIG. 1. Accordingly, when the working chamber 5 is filled with working medium, which is accelerated radially outward in the working chamber by the blading of the rotor 1 and enters into stator 2 on its outer circumference, in which it is retarded radially inward, a portion of the working medium, which exists under a comparatively high pressure, is carried off and the mentioned front end of the piston 4.1 is loaded by this working medium through the channel 11. Accordingly, as long as the retarder is found in braking operation, a correspondingly high pressure prevails in the channel 11, which is formed at least partially—for example, in its end section behind the piston 4.1—as an annular channel, and this pressure keeps the piston 4.1 in its out-of-operation position—in its left-side position in FIG. 3—and thus maintains the coupling 4 in its activated state.

As is shown in FIG. 1, a portion of the working medium, which exits via the back wall of the blading of the stator 2 in the region of the radially outer circumference, can be diverted, at the same time, radially outward into the annular heat exchanger 7, where it is subsequently cooled. As is seen, the working medium that is supplied to the channel 11 is also drawn off through the same opening or through the same openings in the back wall of the stator blading.

Depicted in reference once again to FIG. 3 is a bearing 4.3, which is designed as an axial ball bearing, the outer bearing ring of which is joined axially to the piston 4.1, so that it also undergoes the axially displacement movement of the piston 4.1. On account of the type of sliding attachment of the piston 4.1 in the stator 2, the piston 4.1 and thus the outer bearing ring of the bearing 4.3 is kept rotationally fixed in the circumferential direction. Also coming into consideration, however, is an attachment that enables a rotational movement of piston 4.1 and the bearing outer ring.

The bearing 4.3 has a bearing inner ring, which is joined to a coupling element 4.2. The coupling element 4.2 is mounted on the fan shaft 3.1 so as to be axially movable, preferably by means of a shift toothed gearing, as it is depicted schematically in FIG. 3, for example. Here, the coupling element 4.2 is in rotational engagement with the fan shaft 3.1; that is, the coupling element 4.2 is joined in a rotationally rigid manner to the fan shaft 3.1 in the circumferential direction.

When the piston 4.1 then makes a movement of displacement into its out-of-operation position—the active position of the coupling 4—on account of pressure being applied to it by the working medium, it displaces the coupling element 4.2 axially on the fan shaft 3.1 over the outer bearing ring of the bearing 4.3, which transmits this movement of displacement via the ball bearings to the inner bearing ring. The coupling element 4.2 is thus axially displaced likewise into out-of-operation position with respect to its arrangement on the fan shaft 3.1. The coupling element 4.2 is provided on its front side with a friction lining 4.4, which faces the rotor 1 of the retarder. In its out-of-operation position, this friction lining 4.4 engages on rotor 1 in a friction engagement, by means of which the rotational movement of the rotor 1 is transmitted via the friction lining 4.4 and the coupling element 4.2 onto the fan shaft 3.1 and thus onto the entire fan wheel 3. Accordingly, when the friction coupling is closed between the fan wheel 3 and the rotor 1, the fan wheel 3 runs at the speed or nearly at the speed of the rotor. The active state of the coupling 4 is attained and the retarder is cooled by the air flow produced by the fan wheel 3 during braking operation.

On going from braking operation to non-braking operation, the pressure in the working medium at the connection site of the channel 11 on the working chamber 5 will drop and the application of pressure to the front end of the piston 4.1 by the working medium will decline. The piston will be displaced by an axial force, which opposes the pressure applied by the working medium and is produced, for example, by means of a spring (not depicted) or is produced in another way, into its engaged position, that is, into the inactive position of the coupling 4—into its right-side position in FIG. 3. Here, it is also conceivable that the counterpressure is produced by working medium as well, which is tapped at a suitable site of the working medium circuit that has a higher pressure than the point of connection of the channel 11 in the transition from braking operation to non-braking operation.

On account of the axial movement that the piston 4.1 makes on going from braking operation to non-braking operation, the coupling element 4.2 is also displaced into its axially engaged position—as is readily understood—that is, it makes an axial movement toward the right for an embodiment such as depicted in FIG. 3. This engagement movement of the coupling element 4.2 when the coupling 4 goes from its active position to its inactive position results in the friction lining 4.4 being brought out of engagement with the rotor 1 and thus results in a loss of motive force to the fan shaft 3.1. Accordingly, the fan wheel 3 goes into idle spinning and finally comes to a standstill.

In order to delay this switching-off operation of the air cooling by the fan wheel 3, a pressure reservoir (not depicted) can be provided in the region of the channel 11, that is, between the piston 4.1 and the working chamber 5, and this reservoir delays the pressure drop in the working medium applied to the piston 4.1. The result of this is that, on account of the prevailing prolongation of the activation pressure by the working medium, the piston 4.1 only slides with a delay from its out-of-operation position to its engaged position and that it accordingly triggers the driven connection between rotor 1 and fan 3 only at a given point in time after the retarder is switched off. Accordingly, a subsequent ventilation of the retarder by the air flow produced by the fan wheel 3 takes place over a certain period of time.

In accordance with a special embodiment of the invention, additional assemblies can be automatically coupled to the rotor 1 in a driven connection by means of the coupling 4 according to the invention upon the transition from non-braking operation to braking operation and once again disengaged from this driven connection on going from braking operation to non-braking operation. Such assemblies may, for example, be consuming devices, the engagement of which is desired only in braking operation, or they may be certain auxiliary drives that are to work exclusively in braking operation. Finally, measuring devices—for example, an impeller of a speedometer—may be coupled to the rotor 1 via the coupling 4 during braking operation.

The braking device of the invention has various advantages. First, on account of its compact design, which requires no external cooling circuit, it is also suitable for smaller vehicles, such as trailers or small trucks. Coming into particular consideration is the design of a recreational vehicle or of a camping trailer with a braking device of the invention such as it is described here. The use of the braking device of the invention in such a recreational vehicle or camping trailer makes it possible to equip these vehicles, which, up to now, have had to make do without any wear-free sustained-action brakes due to the cost involved, with cost-favorable, wear-free, sustained-action brakes and thus to relieve the service brakes that are provided in any case and to prolong the service life of the latter.

On account of the use of a ribbed or bladed fan wheel, an additional braking effect is produced. Up to now, any additional braking effect has meant an increase in the flow of heat to be carried away from the retarder. In accordance with the present invention, by contrast, additional braking effect is achieved and the retarder is actively cooled at the same time.

Finally, during non-braking operation, no loss or only a slight loss in power is produced, because the fan wheel is at a standstill during non-braking operation. At the same time, the activation of the fan wheel on going from non-braking operation to braking operation and the deactivation of the latter on going from braking operation to non-braking operation occurs without additional energy expenditure in a fully automatic manner by means of the energy that is already present in the system.

1.-15. (canceled)

16. A braking device, comprising:
a rotor;
a stator being arranged relative to said rotor;
a working medium being selectively supplied so that brake torque is transmitted from said rotor to said stator during a braking operation;
a coupling being activated or deactivated by said working medium; and
a fan wheel being switched into and out of a driven connection with said rotor via activation and deactivation of said coupling, respectively, said fan wheel supplying a flow of cool air to the braking device when said fan wheel is switched into said driven connection with said rotor.

17. The braking device of claim 16, wherein the braking device is an eddy current brake, said working medium is an electric current, and said coupling is actuated electromagnetically.

18. The braking device of claim 16, wherein the braking device is a hydrodynamic retarder, said hydrodynamic retarder having a working chamber that can be filled with said working medium and then drained, said working medium is a liquid, and said coupling is actuated by applying pressure with said working medium.

19. The braking device of claim 18, wherein said coupling comprises a piston in working-medium-conveying connection with said working chamber so that when said working chamber is filled with said working medium, said piston is pressure-loaded with said working medium, said piston being movable such that when said piston is pressure-loaded with said working medium, there is a mechanical coupling engagement between said fan wheel and said rotor.

20. The braking device of claim 19, wherein said piston is designed as an annular piston having an axial central axis that coincides with an axis of rotation of said rotor.

21. The braking device of claim 19, wherein said fan wheel has a fan shaft having a coupling element that can move on said fan shaft, said coupling element being in rotationally rigid connection with said fan wheel, said coupling element defining one part of said coupling, said piston being movable in an axial direction on said fan shaft, and said piston and said coupling element being rigidly joined in the axial direction.

22. The braking device of claim 21, wherein said piston and said coupling element are joined by an axial bearing.

23. The braking device of claim 21, wherein said fan shaft is a hollow shaft that surrounds said rotor shaft.

24. The braking device of claim 21, wherein said coupling element is mounted in a shift toothed gearing on said fan shaft.

25. The braking device of claim 21, wherein said coupling element has a ring-shaped form, said coupling element bearing a friction lining and a front side facing said rotor.

26. The braking device of claim 21, wherein said fan shaft is supported by at least one bearing inside said stator.

27. The braking device of claim 18, wherein said fan wheel is arranged at a front side of said stator axially on an opposite side in relation to said rotor.

28. The braking device of claim 18, wherein, during the braking operation, said working medium is guided through an annular heat exchanger that is arranged radially outside of said working chamber, said working medium being subjected to the flow of cool air.

29. The braking device of claim 18, further comprising a pressure reservoir in a working-medium-carrying connection between said working chamber and said coupling, said pressure reservoir delaying a pressure drop of said working medium by draining said working chamber in a region of said coupling.

30. The braking device of claim 16, further comprising additional assemblies being automatically coupled to said rotor in a driven connection by said coupling during the braking operation.
